(19) United States
(12) Patent Application Publication
(10) Pub. No.: US 2025/0377863 A1
(43) Pub. Date: Dec. 11, 2025

(54) CONTENT GENERATION BASED ON DOMAIN-SPECIFIC LANGUAGE DOMAINS

(71) Applicant: Microsoft Technology Licensing, LLC, Redmond, WA (US)

(72) Inventor: Samuel Edward SCHILLACE, Portola Valley, CA (US)

(73) Assignee: Microsoft Technology Licensing, LLC, Redmond, WA (US)

(21) Appl. No.: 18/737,777

(22) Filed: Jun. 7, 2024

(51) Int. Cl. G06F 8/30; G06F 8/41; G06F 40/143

(52) U.S. Cl. CPC G06F 8/31; G06F 8/42; G06F 40/143

(57) ABSTRACT

A computing system is provided, comprising processing circuitry and associated memory. The processing circuitry is configured to receive a prompt including a message as natural language input from an interaction interface, extract an intent of the message, and select a domain-specific language (DSL) domain corresponding to the intent of the message. The processing circuitry then generates a DSL plan encoded in a DSL based on the message and the selected DSL domain, generates code based on the message and the generated DSL plan, executes the code in a code execution environment to generate content corresponding to the message and the selected DSL domain, and outputs the generated content.

### BACKGROUND

In the field of artificial intelligence, large language models (LLMs) have demonstrated significant capabilities in generating text, processing natural language, and performing a variety of tasks that require understanding and generating human-like responses. However, despite their impressive functionalities, LLMs face substantial limitations, particularly when tasked with executing complex, multi-step processes over extended periods of time.

Conventional machine learning models, including LLMs, are prone to several key issues. One of the most prominent is the tendency to accumulate “hallucinations” or generate information that, while plausible, may not be accurate or based on factual data. This phenomenon is often attributed to the models' training on vast datasets that contain noise and inconsistencies, leading to challenges in maintaining precision in their outputs. As models generate longer texts or attempt to handle more complex tasks, these inaccuracies can accumulate, significantly impacting the reliability of the output.

Another major challenge is the inherent limitations of LLMs concerning task continuity and long-term memory. Current models typically operate with a limited intent window, beyond which they cannot retain information. This restricts their ability to handle long-term projects that require sustained attention and consistency over time, such as writing a textbook or developing a comprehensive website. These tasks necessitate an understanding of large bodies of work and the ability to make coherent additions in a manner that remains consistent throughout the entire project.

Moreover, executing a series of interconnected tasks-each dependent on the outcome of the previous one-presents a complex challenge for LLMs. The conventional models lack the capability to plan over long horizons or execute sequences of operations that require recalling specific outcomes from earlier steps. This limitation significantly hampers their utility for more sophisticated applications, where multiple, detailed tasks must be coordinated and executed in a precise and orderly fashion.

### SUMMARY

To address the above issues, a computing system is provided, comprising processing circuitry and associated memory. The processing circuitry is configured to receive a prompt including a message as natural language input from an interaction interface, extract an intent of the message, and select a domain-specific language (DSL) domain corresponding to the intent of the message. The processing circuitry then generates a DSL plan encoded in a DSL based on the message and the selected DSL domain, generate code based on the message and the generated DSL plan, execute the code in a code execution environment to generate content corresponding to the message and the selected DSL domain, and output the generated content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view showing a computing system according to a first example implementation.

FIG. 2 is a schematic view showing a computing system according to a second example implementation.

FIG. 3 is a schematic view showing an example of the computing system of FIG. 1 or FIG. 2 being used to generate a book in accordance with an intent of a user's prompt.

FIG. 4 is a schematic view showing an example of the computing system of FIG. 1 or FIG. 2 being used to generate a book in accordance with an intent of a user's prompt.

FIG. 5 shows a flowchart for a first method for generating a response to a prompt from a user.

FIG. 6 shows a flowchart for a second method generating a website in response to a prompt from a user.

FIG. 7 shows a schematic view of an example computing environment in which the computer device of FIG. 1 or FIG. 2 may be enacted.

### DETAILED DESCRIPTION

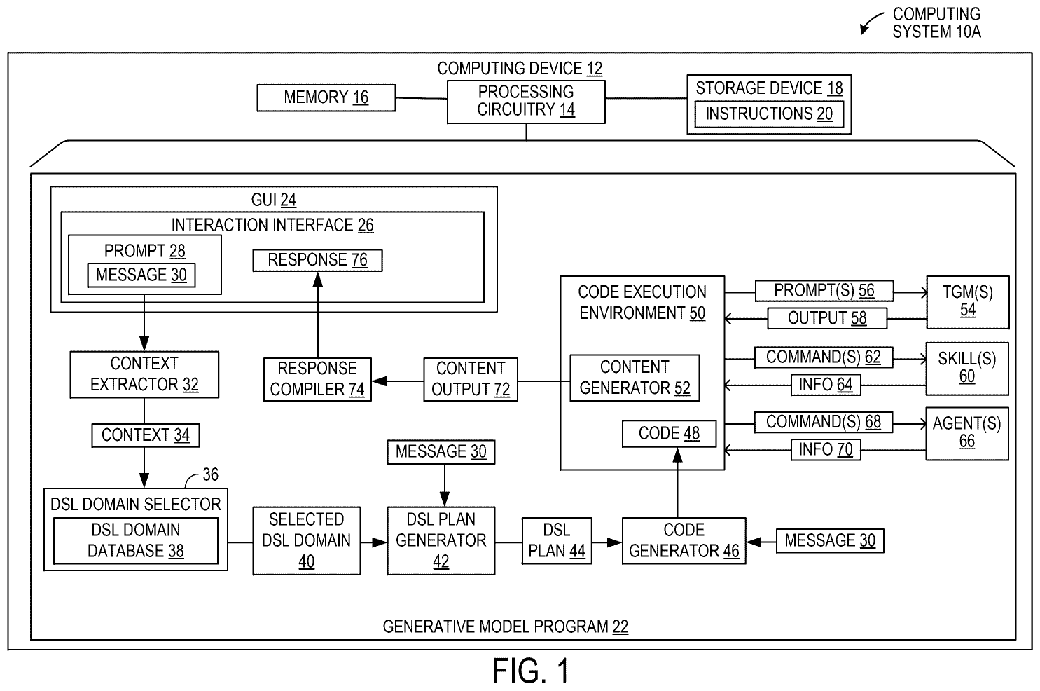

To address the issues described above, referring to FIG. 1, a computing system 10A is provided according to a first example implementation to generate a response 76 based on a prompt 28 of a user. The computing system 10A includes a computing device 12 having processing circuitry 14, memory 16, and a storage device 18 storing instructions 20. In this first example implementation, the computing system 10A takes the form of a single computing device 12 storing instructions 20 in the storage device 18, including a domain-specific language (DSL) domain selector 36, a DSL domain database 38, a DSL plan generator 42, a code generator 46, a code execution environment 50, and a generative model program 22 that is executable by the processing circuitry 14 to perform various functions including causing an interaction interface 26 to be presented. The interaction interface 26 receives a prompt 28 including a message 30 from the user. The processing circuitry 14 further executes an intent extractor 32 to extract an intent 34 of the message 30.

The DSL domain selector 36 is executed to select a DSL domain 40 from the DSL domain database 38 based on the extracted intent 34. The DSL domain database 38 may comprise several selectable DSL domains, including a book domain, report domain, and a website domain, for example. The selected DSL domain 40 is inputted into the DSL plan generator 42 to generate a DSL plan 44 corresponding to the selected DSL domain 40. The generated DSL plan 44 and the message 30 are inputted into a code generator 46 to generate code 48, which is executed in a code execution environment 50 to generate a content output 72. A response compiler 74 compiles the content output 72 to generate the final response 76.

The DSL plan generator 42 generates a DSL plan 44 encoded in a DSL for executing a desired task in accordance with the intent 34 of the user. DSLs are specialized high-level languages that are adapted for describing high-level tasks in a particular DSL domain 40. Examples of selectable DSL domains in the DSL domain database 38 include books, reports, websites, surveys, newsletters, presentations, manuals, graphical applications, mathematical applications, and statistical applications. Non-limiting examples of domain-specific languages include customized versions of SQL (structured query language), HLSL/GLSL (High-Level Shading Language/Graphics Library Shader Language), Terraform language, MATLAB, R, machine learning languages, Ansible, and Cucumber.

Existing languages may be modified and adapted to be easily translatable into lower level computer code, such as Python or C#, for example. For example, existing web development languages such as HTML5 or XML may be modified into a web development DSL, so that when the intent 34 of the message 30 is determined to be related to web development, the DSL plan 44 is generated in a web development DSL, and the code 48 is generated in a web development language. In other words, the syntax and semantics of the existing languages may be leveraged while ensuring that they can be efficiently translated into lower-level computer code. For example, when adapting SQL as a DSL, SQL may be modified to include additional constructs to handle more general-purpose programming tasks, such as conditional logic or loops, to make them more compatible for translation into languages such as Python or C#.

The DSL plan 44 provide step-by-step instructions comprising a sequence of high-level tasks or abstractions that reflect the high-level concepts of the particular DSL domain 40, which may include individual chapters of a book, or individual sections of a report, for example. The DSL plan 44 may include termination conditions for terminating the execution of the code 48, orders of tasks and processes, and orders of subtasks encapsulated within individual tasks. The DSL plan 44 may also be checked for errors at runtime. By using a plan 44 encoded in a DSL to generate the code 48, the response 76 can be generated by performing tasks that are highly organized and structured in accordance with a DSL plan 44 that corresponds to the particular DSL domain 40 corresponding to the intent 34 of the user's prompt 28.

The generated DSL plan 44 may be presented to the user in the interaction interface 26 for user confirmation. The user may review the steps outlined in the DSL plan 44 and confirm that the DSL plan 44 conform to the intent 34 of the user. Upon receiving a user confirmation, the code generator 46 converts the DSL plan 44 into executable code 48. For each high-level task in the DSL plan 44, the code generator 46 generates executable code specific to performing the high-level task. The coding languages in which the executable code 48 is encoded is not limited, and may include general-purpose programming languages including Python, Java, C#, and JavaScript, web development languages including HTML, CSS, and PHP, and platform-specific languages including Swift, Kotlin, Ruby on Rails, and Django. The code generator 46 may also accept input of the message 30 of the user's prompt 28 to generate the code 48.

The code execution environment 50 is configured with the runtime libraries and dependencies used to execute the generated code 48. The environment 50 may also be equipped with APIs and middleware that facilitate communication and data exchange with external components, so that when the generated code 48 is executed, the environment 50 may interact with one or more trained generative models 54, one or more skills 60, and more or more agents 66 to generate the content output 72. The skills 60 and agents 66 may be instantiated as specialized software modules configured to handle specific domains of tasks or requests. For example, the skills 60 and agents 66 may be generative modules configured with specialized algorithms or processing capabilities to execute specific tasks in various specialized domains, which may include but are not limited to finance, healthcare, artwork, game design, and food services. The skills 60 and agents 66 are configured to retrieve information and/or perform tasks that directly align with their areas of expertise. In this example, one or more commands 62 are sent to the skill 60 by the code execution environment 50. In response, the skill 60 transmits information 64 back to the code execution environment 50. For example, the skill 60 may be a currency conversion skill which transmits the latest currency conversion rates as information 64 back to the code execution environment 50.

Data fetched from various trained generative models 54, skills 60, and agents 66 may be processed and integrated into the content output 72 generated by the executed code 48. The generated content output 72 is subsequently deployed or formatted by the response compiler 74 to generate the final response 76 or digital product.

Likewise, one or more commands 68 are sent to the agent 66, and in response, the agent 66 transmits information 70 back to the code execution environment 50. For example, the agent 66 may be an academic paper retrieval agent which transmits a requested academic paper as the information 70 in response to a command 68.

The content generator 52 integrates the execution output of each high-level task in the DSL plan 44 to produce the content output 72, which is compiled by the response compiler 74 to generate the final response 76 or final task output which is displayed on the interaction interface 26.

It will be appreciated that, in alternative embodiments, after a DSL domain is selected, the code generator 46 may handle both the generation of the DSL plan 44 and the code 48, so that the DSL plan generator 42 is omitted from the generative model program 22.

The trained generative language model 54 is a generative model that has been configured through machine learning to receive prompts 56 from the code execution environment 50, and generate output 58 that includes natural language text in response to the prompts 56. The output 58 from the trained generative model 54 is used by the code execution environment 50 to generate the content output 72. It will be appreciated that the trained generative language model 54 can be a large language model (LLM) having tens of millions to billions of parameters, non-limiting examples of which include GPT-3, BLOOM, and LLaMa-2. The trained generative language model 54 can be a multi-modal generative model configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output. Non-limiting examples of multi-modal generative models include Kosmos-2 and GPT-4 VISUAL. Further, the trained generative language model 54 can be configured to have a generative pre-trained transformer architecture, examples of which are used in the GPT-3 and GPT-4 models. Other architectures, such as state space models (SSMs), can alternatively be used for the generative language model 54 and other trained generative models discussed herein.

It will be noted that the DSL domain selector 36, the DSL plan generator 42, and/or the code generator 46 may also be implemented as trained generative models like the trained generative model 54 which interfaces with the code execution environment 50.

In some instances, the interaction interface 26 may be a portion of a graphical user interface (GUI) 24 for accepting user input and presenting information to a user. In other instances, the interaction interface 26 may be presented in non-visual formats such as an audio interface for receiving and/or outputting audio, such as may be used with a digital assistant. In yet another example the interaction interface 26 may be implemented as an application programming interface (API). In such a configuration, the input to the interaction interface 26 may be made by an API call from a calling software program to the interaction interface API, and output may be returned in an API response from the interaction interface API to the calling software program. The API may be a local API or a remote API accessible via a computer network such as the Internet. It will be understood that distributed processing strategies may be implemented to execute the software described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example.

Thus, the processing circuitry 14 may be configured to execute the interaction interface API (for example, interaction interface 26), so that the processing circuitry 14 is configured to interface with the trained generative model 54 that receives input of the prompt 28 including natural language text input and, in response, generates a response 76 that includes natural language text output. Likewise, communications between the code execution environment 50 and the trained generative models 54, skills 60, and agents 66 can be implemented using local or remote APIs.

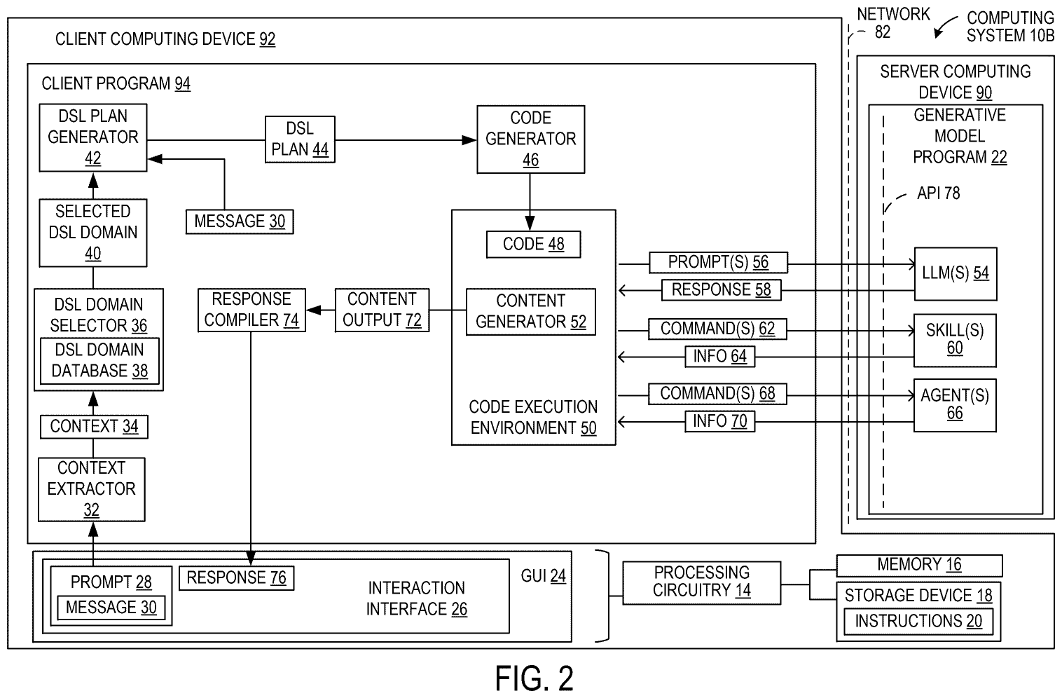

Turning to FIG. 2, a computing system 10B according to a second example implementation is illustrated, in which the computing system 10B includes a server computing device 90 and a client computing device 92 which communicate with each other via a network 82 such as the Internet. Here, both the server computing device 90 and the client computing device 92 may include respective processing circuitry 14, memory 16, and storage devices 18. Description of identical components to those in FIG. 1 will not be repeated. As shown in FIG. 2, the one or more trained generative models 54, skills 60, and agents 66 can be stored and executed on a different server 90 from the client computing device 92. The interaction interface 26 is executed by the client computing device 92, which stores and executes the client program 94 including the intent extractor 32, DSL domain selector 36, DSL domain database 38, DSL plan generator 42, code generator 46, code execution environment 50, and response compiler 74. The client program 94 executed on the client computing device 92 can send prompts 56 or commands 62, 68 to an API 78 of the generative model program 22 on the different server 90 across a computer network such as the Internet, and in turn receive a response, in some examples.

It will be appreciated that the server computing device 90 may be one of a plurality of servers in a server pool that is configured to implement a cloud computing platform, and that the generative model program 22 may be accessed via an API 78 of the cloud computing platform. The generative model program 22 may be implemented in a virtual machine or containerized computing environment on the server computing device 90, in some configurations. Accordingly, the client computing device 92 may fetch data from the trained generative models 54, skills 60, and agents 66 via external API calls. The client computing device 92 may also execute tasks via the skills 60 and agents 66 via external API calls.

The client computing device 92 may be configured to present the interaction interface 26 as a result of executing a client program 94 by the processing circuitry 14 of the client computing device 92. The client computing device 92 may be responsible for communicating between the user operating the client computing device 92 and the server computing device 90 which executes the generative model program 22 and contains respective trained generative models 54, skills 60, and agents 66 via an API 78 of the generative model program 22. The client computing device 92 may take the form of a personal computer, laptop, tablet, smartphone, smart speaker, etc.

Further, the generative language models 54 may be executed on a different server from the server computing device 90 depicted in FIG. 2, so that the client computing device 92 is in communication with the generative language models 54 hosted on different external servers via a network 82, such as the Internet. In such an embodiment, the server computing device 90 may invoke an API call to transmit a data request to a different external server executing the generative language models 54. Upon receipt of the data request, the external server may decode the incoming API call and extract input parameters, receiving input of the prompt including natural language text input. The generative language models 54 hosted on the different external server may perform its operation and generate a response that includes natural text output. The response may be received by the server computing device 90 and subsequently transmitted back to the client computing device 92 via the API 78.

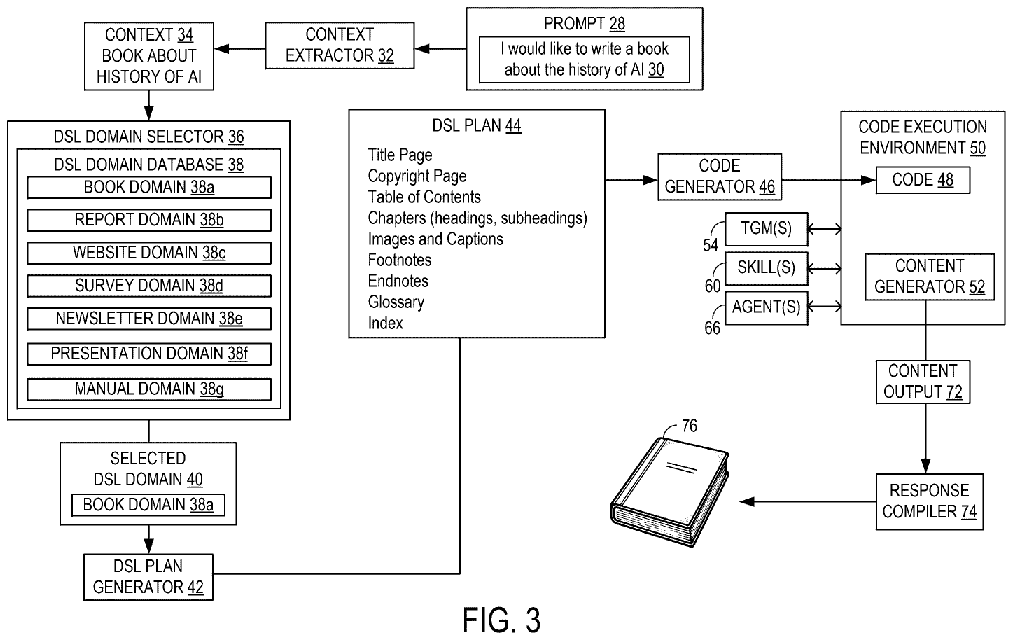

Turning now to FIG. 3, in one example implementation, the generative model program 22 may generate a book as a response 76 to a user prompt 28 with a message 30, “I would like to write a book about the history of artificial intelligence”. The intent extractor 32 extracts the intent 34 of the message 30 as, “book about the history of artificial intelligence”. In response, the DSL domain selector 36 selects from among the available domains 38a-g in the DSL domain database 38, the corresponding DSL domain 40 for the extracted intent 34. In this example, the DSL domain database 38 includes a book domain 38a, a report domain 38b, a website domain 38c, a survey domain 38d, a newsletter domain 38e, a presentation domain 38f, and a manual domain 38g. The DSL domain selector 36 selects the book domain 38a as the selected DSL domain 40. The DSL plan generator 42 generates the DSL plan 44 in accordance with the selected DSL domain 40. The DSL plan generator 42 may also receive additional input necessary to generate the DSL plan 44, including the original prompt 28 from the user.

The DSL plan 44 outlines the outline of the final response 76. In this example, the DSL plan 44 for the book outlines the individual sections of the book, including a title page, a copyright page, a table of contents, individual chapters with headings and subheadings, images and captions, footnotes, endnotes, glossary, and index. Based on the generated DSL plan 44, the code generator 46 generates the code 48 that, when executed in the code execution environment 50, will structure the book 76 according to the selected DSL plan 44 and populate it with content relevant to the history of artificial intelligence. The code 48 may be written in Python, for example.

The generated code 48 is subsequently executed in a secure code execution environment 50 which interfaces with various generative language models 54, skills 60, and agents 66 to draft sections of the book 76 as content output 72, incorporating data from various resources and ensuring factual accuracy. The response compiler 74 then compiles the generated content output 72 into a formatted book, ready for digital publication.

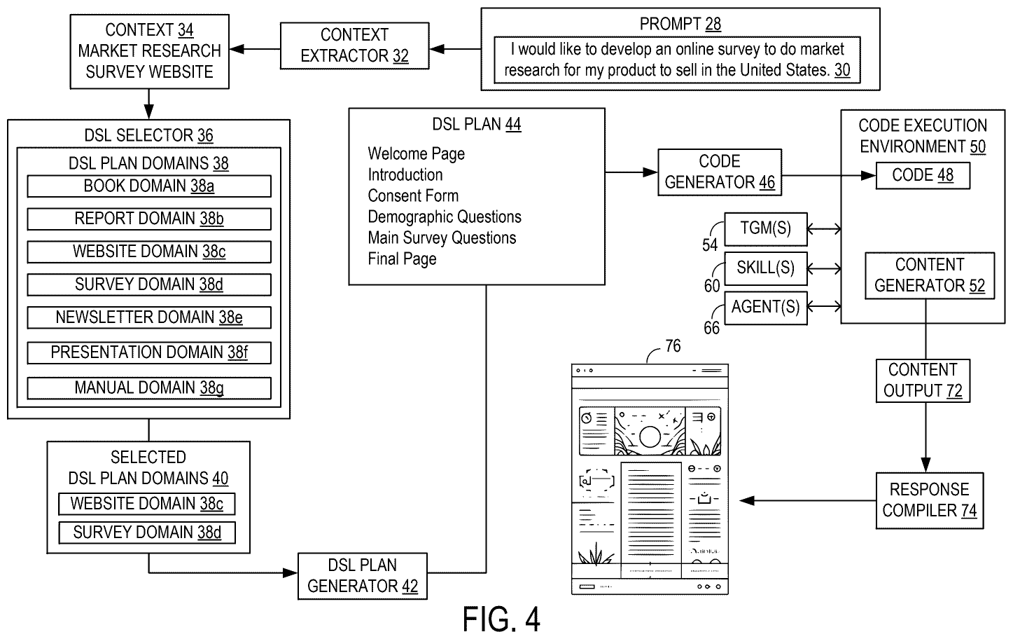

Turning now to FIG. 4, in another example implementation, the generative model program 22 may generate a website as a response 76 to a user prompt 28 with a message 30, “I would like to develop an online survey to do market research for my product to sell in the United States”. The intent extractor 32 extracts the intent 34 of the message 30 as “market research survey website”. In response, the DSL domain selector 36 selects from among the available domains 38a-g in the DSL domain database 38, the corresponding DSL domain 40 for the extracted intent 34. The DSL domain selector 36 selects the website domain 38c and the survey domain 38d as the selected DSL domains 40. The DSL plan generator 42 generates the DSL plan 44 in a web development DSL in accordance with the selected DSL domain 40. The DSL plan generator 42 may also receive additional input necessary to generate the DSL plan 44, including the original prompt 28 from the user.

The DSL plan 44 outlines the outline of the final response 76. In this example, the DSL plan 44 for the website outlines the individual sections of the website, including a welcome page, an introduction page, a consent form, demographic questions, main survey questions, and a final page. Based on the generated DSL plan 44, the code generator 46 generates the code 48 in a web development framework that, when executed in the code execution environment 50, will structure the website 76 according to the selected DSL plan 44 and populate it with content relevant to the history of artificial intelligence. The code 48 may be written using a Python web framework such as Flask, along with HTML embedded in Python, for example.

The generated code 48 is subsequently executed in a secure code execution environment 50 which interfaces with various generative language models 54, skills 60, and agents 66 to draft sections of the website 76 as content output 72 or a draft website, incorporating data from various resources and ensuring factual accuracy. The response compiler 74 then deploys the draft website 72 as a live website 76 that is publicly accessible on the internet. For example, the response compiler 74 may upload the compiled code and dependencies to a web server or cloud platform and push the website to a live environment.

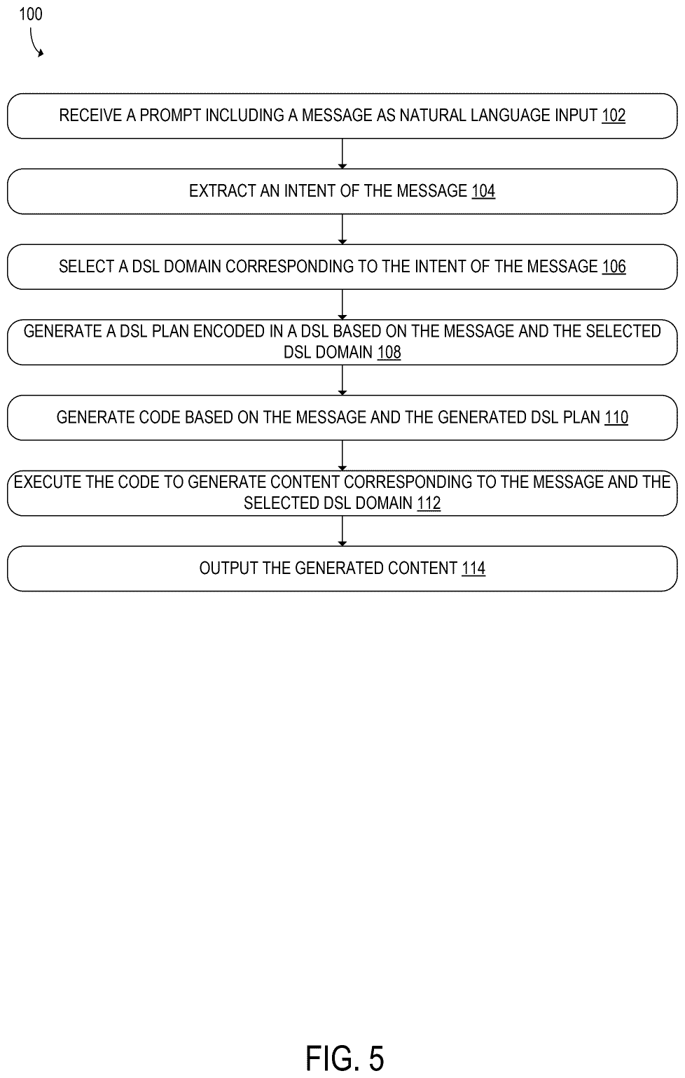

FIG. 5 is a flowchart that illustrates a first method 100 for generating a response based on a user prompt. The first method 100 may be implemented on the computing system 10A or 10B illustrated in FIGS. 1-2 above, which include processing circuitry and associated memory configured to implement an interaction interface, content extractor, a DSL domain selector, a DSL plan generator, a code generator, a code execution environment, and a response compiler.

At 102, the method includes, at the interaction interface, receiving a prompt including a message as natural language input. At 104, the method includes, at the content extractor, extracting an intent of the message. At 106, the method includes, at the DSL domain selector, selecting a DSL domain corresponding to the intent of the message. At 108, the method includes, at the DSL plan generator, generating a DSL plan encoded in a DSL based on the message and the selected DSL domain. At 110, the method includes, at the code generator, generating code based on the message and the generated DSL plan. At 112, the method includes executing the code to generate content corresponding to the message and the selected DSL domain. At 114, the method includes outputting the generated content.

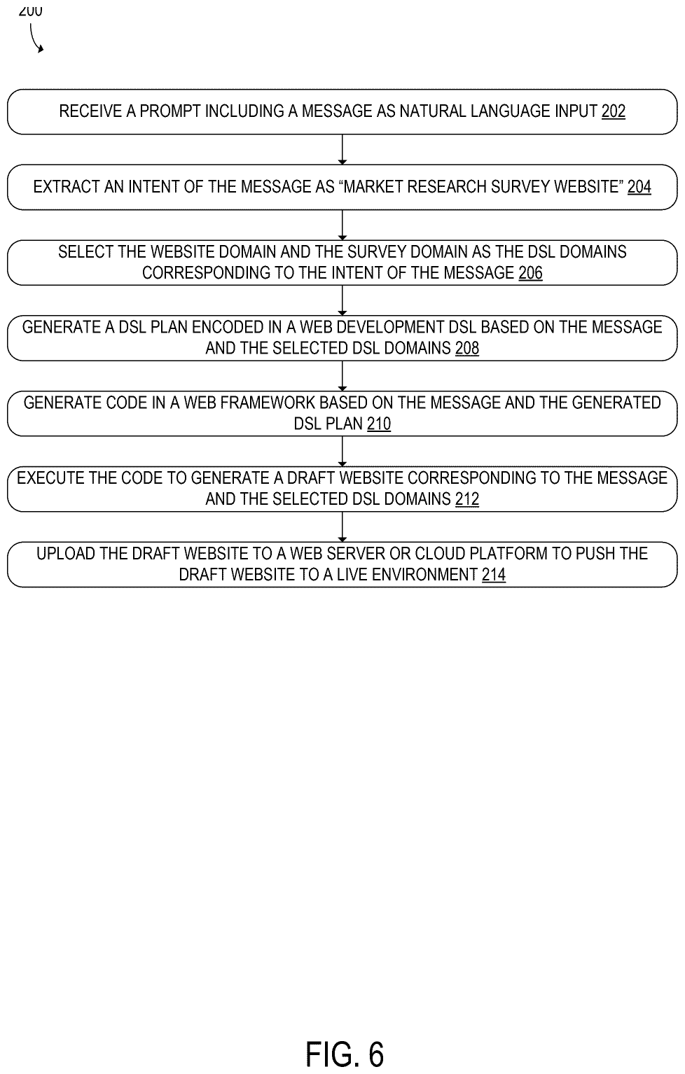

FIG. 6 is a flowchart that illustrates a second method 200 for generating a response based on a user prompt. The second method 200 may be implemented on the computing system 10A or 10B illustrated in FIGS. 1-2 and 4 above, which include processing circuitry and associated memory configured to implement an interaction interface, content extractor, a DSL domain selector, a DSL plan generator, a code generator, a code execution environment, and a response compiler.

At 202, the method includes, at the interaction interface, receiving a prompt including a message as natural language input. At 204, the method includes, at the content extractor, extracting an intent of the message as “market research survey website”. At 206, the method includes, at the DSL domain selector, selecting the website domain and the survey domain as the DSL domains corresponding to the intent of the message. At 208, the method includes, at the DSL plan generator, generating a DSL plan encoded in a web development DSL based on the message and the selected DSL domains. At 210, the method includes, at the code generator, generating code in a web framework based on the message and the generated DSL plan. At 212, the method includes executing the code to generate a draft website corresponding to the message and the selected DSL domains. At 214, the method includes uploading the draft website to a web server or cloud platform to push the draft website to a live environment.

The above-described systems and method enable users, even those without specialized expertise, to produce customized content swiftly and efficiently based on prompts that are inputted into interaction interfaces. Rather than tasks being performed in isolation, tasks are executed in a coordinated and orderly manner as part of a larger, organized plan. Each small task is executed in service of a larger task, which in turn fulfills the overarching plan outlined in the domain-specific language. This structured approach ensures that the entirety of the plan is coherent and that each component task contributes to the final goal of generating the final response. Accordingly, the user's intents are effectively and efficiently translated into executable plans and actions by leveraging domain-specific languages to fulfill diverse tasks.

In some embodiments, the methods and processes described herein may be tied to a computing system of one or more computing devices. In particular, such methods and processes may be implemented as a computer-application program or service, an application-programming interface (API), a library, and/or other computer-program product.

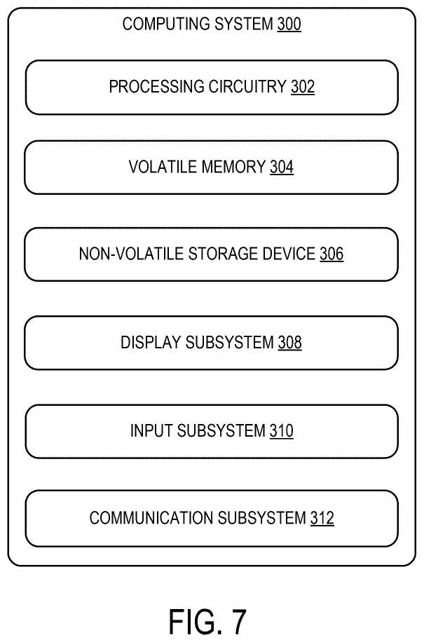

FIG. 7 schematically shows a non-limiting embodiment of a computing system 300 that can enact one or more of the methods and processes described above. Computing system 300 is shown in simplified form. Computing system 300 may embody the computing system 10A or 10B described above and illustrated in FIGS. 1 and 2, respectively. Components of computing system 300 may be included in one or more personal computers, server computers, tablet computers, home-entertainment computers, network computing devices, video game devices, mobile computing devices, mobile communication devices (for example, smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 7.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed-e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included display subsystem 308 may be used to present a visual representation of data held by non-volatile storage device 306. The visual representation may take the form of a GUI. As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional support for the claims of the subject application. One aspect provides computing system comprising processing circuitry and associated memory configured to receive a prompt including a message as natural language input from an interaction interface, extract an intent of the message, select a domain-specific language (DSL) domain corresponding to the intent of the message, generate a DSL plan encoded in a DSL based on the message and the selected DSL domain, generate code based on the message and the generated DSL plan, execute the code in a code execution environment to generate content corresponding to the message and the selected DSL domain, wherein the code execution environment is configured to interact with one or more trained generative models to generate the content, and output the generated content. In this aspect, additionally or alternatively, the DSL may be based on at least one language selected from the group consisting of SQL (structured query language), HLSL/GLSL (High-Level Shading Language/Graphics Library Shader Language), Terraform language, MATLAB, R, machine learning languages, Ansible, and Cucumber. In this aspect, additionally or alternatively, a syntax and semantics of the at least one language may be modified to include additional constructs to handle general-purpose programming tasks. In this aspect, additionally or alternatively, the one or more trained generative models may have a generative pre-trained transformer architecture. In this aspect, additionally or alternatively, the one or more trained generative models may be a large language model. In this aspect, additionally or alternatively, the code execution environment may be configured to interact with one or more agents to execute tasks in specialized domains to generate the content. In this aspect, additionally or alternatively, the DSL domain may be at least one selected from the group consisting of a book domain, a report domain, a website domain, a survey domain, a newsletter domain, a presentation domain, and a manual domain. In this aspect, additionally or alternatively, when the intent of the message is related to web development, the DSL plan may be generated in a web development DSL, and the code may be generated in a web development language. In this aspect, additionally or alternatively, the DSL domain may be selected using a trained generative model receiving the intent of the message as input. In this aspect, additionally or alternatively, the DSL plan may be generated using a trained generative model receiving the selected DSL domain as input.

Another aspect provides a computing method comprising receiving a prompt including a message as natural language input from an interaction interface, extracting an intent of the message, selecting a domain-specific language (DSL) domain corresponding to the intent of the message, generating a DSL plan encoded in a DSL based on the message and the selected DSL domain, generating code based on the message and the generated DSL plan, executing the code in a code execution environment to generate content corresponding to the message and the selected DSL domain, wherein the code execution environment is configured to interact with one or more trained generative models to generate the content, and outputting the generated content. In this aspect, additionally or alternatively, the DSL may be based on at least one language selected from the group consisting of SQL (structured query language), HLSL/GLSL (High-Level Shading Language/Graphics Library Shader Language), Terraform language, MATLAB, R, machine learning languages, Ansible, and Cucumber. In this aspect, additionally or alternatively, a syntax and semantics of the at least one language may be modified to include additional constructs to handle general-purpose programming tasks. In this aspect, additionally or alternatively, the one or more trained generative models may have a generative pre-trained transformer architecture. In this aspect, additionally or alternatively, the one or more trained generative models may be a large language model. In this aspect, additionally or alternatively, the code execution environment may be configured to interact with one or more agents to execute tasks in specialized domains to generate the content. In this aspect, additionally or alternatively, the DSL domain may be at least one selected from the group consisting of a book domain, a report domain, a website domain, a survey domain, a newsletter domain, a presentation domain, and a manual domain. In this aspect, additionally or alternatively, when the intent of the message is related to web development, the DSL plan may be generated in a web development DSL, and the code may be generated in a web development language. In this aspect, additionally or alternatively, the DSL domain may be selected using a trained generative model receiving the intent of the message as input.

Another aspect provides a computing system comprising processing circuitry and associated memory configured to receive a prompt including a message as natural language input from an interaction interface, extract an intent of the message, select a domain-specific language (DSL) domain corresponding to the intent of the message, generate code based on the message and the selected DSL domain, execute the code in a code execution environment to generate content corresponding to the message and the selected DSL domain, and output the generated content.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
processing circuitry and associated memory configured to:
receive a prompt including a message as natural language input from an interaction interface;
extract an intent of the message;
select a domain-specific language (DSL) domain corresponding to the intent of the message;
generate a DSL plan encoded in a DSL based on the message and the selected DSL domain;
generate code based on the message and the generated DSL plan;
execute the code in a code execution environment to generate content corresponding to the message and the selected DSL domain, wherein the code execution environment is configured to interact with one or more trained generative models to generate the content; and
output the generated content.

2. The computing system of claim 1, wherein the DSL is based on at least one language selected from the group consisting of: SQL (structured query language), HLSL/GLSL (High-Level Shading Language/Graphics Library Shader Language), Terraform language, MATLAB, R, machine learning languages, Ansible, and Cucumber.

3. The computing system of claim 1, wherein a syntax and semantics of the at least one language are modified to include additional constructs to handle general-purpose programming tasks.

4. The computing system of claim 1, wherein the one or more trained generative models has a generative pre-trained transformer architecture.

5. The computing system of claim 1, wherein the one or more trained generative models is a large language model.

6. The computing system of claim 1, wherein the code execution environment is configured to interact with one or more agents to execute tasks in specialized domains to generate the content.

7. The computing system of claim 1, wherein the DSL domain is at least one selected from the group consisting of a book domain, a report domain, a website domain, a survey domain, a newsletter domain, a presentation domain, and a manual domain.

8. The computing system of claim 1, wherein when the intent of the message is related to web development, the DSL plan is generated in a web development DSL, and the code is generated in a web development language.

9. The computing system of claim 1, wherein the DSL domain is selected using a trained generative model receiving the intent of the message as input.

10. The computing system of claim 1, wherein the DSL plan is generated using a trained generative model receiving the selected DSL domain as input.

11. A computing method comprising:
receiving a prompt including a message as natural language input from an interaction interface;
extracting an intent of the message;
selecting a domain-specific language (DSL) domain corresponding to the intent of the message;
generating a DSL plan encoded in a DSL based on the message and the selected DSL domain;
generating code based on the message and the generated DSL plan;
executing the code in a code execution environment to generate content corresponding to the message and the selected DSL domain, wherein the code execution environment is configured to interact with one or more trained generative models to generate the content; and
outputting the generated content.

12. The computing method of claim 11, wherein the DSL is based on at least one language selected from the group consisting of: SQL (structured query language), HLSL/GLSL (High-Level Shading Language/Graphics Library Shader Language), Terraform language, MATLAB, R, machine learning languages, Ansible, and Cucumber.

13. The computing method of claim 11, wherein a syntax and semantics of the at least one language are modified to include additional constructs to handle general-purpose programming tasks.

14. The computing method of claim 11, wherein the one or more trained generative models has a generative pre-trained transformer architecture.

15. The computing method of claim 11, wherein the one or more trained generative models is a large language model.

16. The computing method of claim 11, wherein the code execution environment is configured to interact with one or more agents to execute tasks in specialized domains to generate the content.

17. The computing method of claim 11, wherein the DSL domain is at least one selected from the group consisting of a book domain, a report domain, a website domain, a survey domain, a newsletter domain, a presentation domain, and a manual domain.

18. The computing method of claim 11, wherein when the intent of the message is related to web development, the DSL plan is generated in a web development DSL, and the code is generated in a web development language.

19. The computing method of claim 11, wherein the DSL domain is selected using a trained generative model receiving the intent of the message as input.

20. A computing system comprising:
processing circuitry and associated memory configured to:
receive a prompt including a message as natural language input from an interaction interface;
extract an intent of the message;
select a domain-specific language (DSL) domain corresponding to the intent of the message;
generate code based on the message and the selected DSL domain;
execute the code in a code execution environment to generate content corresponding to the message and the selected DSL domain; and
output the generated content.
